(19) United States
(12) Patent Application Publication
(10) Pub. No.: US 2026/0076783 A1
(43) Pub. Date: Mar. 19, 2026

(54) ANATOMICAL AND SCANNABLE HEALING ABUTMENTS

(71) Applicant: EVOLLUTION IP HOLDINGS, INC., Birmingham, AL (US)

(72) Inventors: Ashley Lane Boggs, Vestavia Hills, AL (US); Paul William Bell, Vestavia Hills, AL (US); Christian Andreas Geissberger, Vestavia Hills, AL (US)

(21) Appl. No.: 18/886,419

(22) Filed: Sep. 16, 2024

(51) Int. Cl. A61C 8/00

(52) U.S. Cl. CPC A61C 8/008

(57) ABSTRACT

Provided are anatomical and scannable healing abutments and systems of anatomical healing abutments for dental implant surgery. The plurality of different healing abutments each have an anatomical shape corresponding to a different type of a natural tooth. The abutments are marked by marking protocol in which dimple indicators provide visual identification about connection type/size of the healing abutment and a notch indicator provides visual identification about a height of the healing abutment and/or a buccal-lingual orientation of the healing abutment. The healing abutment may also include color coding and/or a surface modification.

### TECHNICAL FIELD

The present disclosure relates generally to the field of restorative implant dentistry, and more particularly to apparatus, systems and methods use of dental components and realizing implant position throughout the process while maintaining support for surrounding gingiva.

### BACKGROUND

Dental implants are commonly used in restorative dentistry to affix a dental prosthesis to the jaw of a human or animal patient. Typically, a dental practitioner installs an externally threaded implant into an aperture formed in the bone of the patient's jaw, to which an artificial tooth, crown, or other dental prosthesis will be attached. After placement of the implant, the surrounding bone tissue is allowed to heal and an abutment mount is secured to the implant, upon which the dental prosthesis is fabricated. Typically, an abutment screw is used to attach the prosthesis to the implant via an anchoring bore through the abutment and into an internally threaded bore in the implant. Optionally, a temporary crown or healing abutment may be attached to the implant during healing and fabrication of a permanent prosthesis.

Generic-shaped healing abutments can be used, but the resultant bone and gingival healing may be less than optimal. Alternatively, healing abutments can be customized for a particular patient, which is expensive and time consuming to manufacture, increasing the time needed for a complete prosthetic fitting.

The location and orientation of a dental implant that has been placed in the patient's jaw can be transferred to a physical dental model by use of an impression coping engaged in the implant (using an analog modeling process), or by a scan body engaged in the implant (using a digital modeling process). In either case, the healing abutment must typically be removed from the implant so that the impression coping or scan body can be attached. Traditionally, removal of the healing abutment causes pain and discomfort to the patient and further irritates and removes support for the gingiva surrounding the implant. Further, common impression copings and scan bodies are typically symmetrical in shape and lack a profile that mimics the anatomy of a natural tooth for supporting the surrounding gingiva, thereby negatively impacting the healing and support of the surrounding gingiva when placed in the implant to take an impression or obtain a scan.

Accordingly, it can be seen that needs exist for improved apparatus, systems, and use of dental components and for realizing implant position throughout the process of restorative implant dentistry while maintaining support for surrounding gingiva. It is to the provision of improved apparatus, systems and methods meeting these and other needs that the present invention is primarily directed.

### SUMMARY

In example embodiments, the present invention provides for anatomical healing abutments and systems of anatomical healing abutments for dental implant surgery.

In one aspect, the present invention relates to a system of anatomical healing abutments for dental implant surgery that includes a plurality of different healing abutments. Each healing abutment can have an anatomical portion corresponding to a shape of a cementoenamel junction of a natural tooth type and a marking protocol comprising at least a first visual marking on a supragingival surface. The first visual marking can be configured to provide visual identification of information to a practitioner about the healing abutment in an oral cavity, and a shape of the supragingival surface can be used to digitally detect an implant's location and/or orientation.

In another aspect, the present invention relates to an anatomical healing abutment that includes a connection portion configured for engagement with a dental implant. The implant also includes an anatomical portion integrally connected to the connection portion, wherein the supragingival surface of the anatomical portion has an anatomical shape which corresponds to a shape of a cementoenamel junction of a natural tooth type. The anatomical healing abutment can include a marking protocol having at least one visual marker that is configured to provide a visual means of identification to the practitioner regarding such as a height and/or buccal-lingual orientation of the anatomical healing abutment. The shape of the supragingival surface can be used digitally to detect implant location and/or orientation, but the marking protocol is not used to digitally detect implant location or orientation.

In still another aspect, the present invention relates to a system of anatomical healing abutments for dental implant surgery that includes at least one healing abutment. The healing abutment can have a connection portion configured for engagement with a dental implant and an anatomical portion integrally connected to the connection portion. The anatomical portion can have an anatomical shape corresponding with a shape of a cementoenamel junction of a natural tooth type. The anatomical portion comprises a supragingival surface, the shape of which supragingival surface is used to digitally to detect implant location and/or orientation. The supragingival surface can also include a first visual marker. The first visual marker can be a notch that conveys visual identification information to the practitioner including a height and/or buccal-lingual orientation of the anatomical healing abutment. The first visual marker is not used digitally to detect implant location and/or orientation. At least one of the healing abutments in the system can also include a second visual marker that can include one or more dimples that provide visual identification information to the practitioner including one or both of size and connection type information. When the healing abutment is engaged with the dental implant, a head of an abutment screw is substantially flush with the supragingival surface to form a seal.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a top (supragingival surface) view of six healing abutment shapes in accordance with embodiments of the present disclosure.

FIGS. 2A-2F provide perspective views of example embodiments of the six healing abutment shapes, depicted in regular and tall heights for each shape. FIG. 2A is an A1 abutment; FIG. 2B is an A2 abutment, FIG. 2C is an M1 abutment; FIG. 2D is an M2 abutment; FIG. 2E is a P1 abutment; and FIG. 2F is a P2 abutment.

FIGS. 3A-3D provide various views of example healing abutments installed into a dental implant, in accordance with embodiments of the present disclosure. FIG. 3A shows one embodiment of a healing abutment configured to seat in an internal recess of the dental implant. FIG. 3B shows another embodiment of a healing abutment configured to seat atop the dental implant. FIGS. 3C and 3D show the healing abutment installed in a dental implant in a patient's oral cavity.

FIGS. 4A-4D provide an example embodiment of an A1 healing abutment for use in the position of a maxillary central incisor. FIG. 4A is a side view from the buccal side. FIG. 4B is a mesial view. FIG. 4C is a cross-sectional view through the 4C-4C plane shown in FIG. 4A. FIG. 4D is a top view showing the supragingival surface.

FIGS. 5A-5D show several views of an embodiment of an A2 healing abutment for use in the position of a maxillary lateral incisor or mandibular incisor. FIG. 5A is a side view from the buccal side. FIG. 5B is a mesial view. FIG. 5C is a cross-sectional view through the 5C-5C plane shown in FIG. 5A. FIG. 5D is a top view showing the supragingival surface.

FIGS. 6A-6D show several views of an embodiment of an M1 healing abutment for use in the position of a maxillary canine. FIG. 6A is a side view from the buccal side. FIG. 6B is a mesial view. FIG. 6C is a cross-sectional view through the 6C-6C plane shown in FIG. 6A. FIG. 6D is a top view showing the supragingival surface.

FIGS. 7A-7D show several views of an embodiment of an M2 healing abutment for use in the position of a premolar or mandibular canines. FIG. 7A is a side view from the buccal side. FIG. 7B is a mesial view. FIG. 7C is a cross-sectional view through the 7C-7C plane shown in FIG. 7A. FIG. 7D is a top view showing the supragingival surface.

FIGS. 8A-8D show several views of an embodiment of a P1 healing abutment for use in the position of a maxillary molar. FIG. 8A is a side view from the buccal side. FIG. 8B is a mesial view. FIG. 8C is a cross-sectional view through the A-A plane shown in FIG. 8A. FIG. 8D is a top view showing the supragingival surface.

FIGS. 9A-9D show several views of an embodiment of a P2 healing abutment for use in the position of a mandibular molar. FIG. 9A is a side view from the buccal side. FIG. 9B is a mesial view. FIG. 9C is a cross-sectional view through the A-A plane shown in FIG. 9A. FIG. 9D is a top view showing the supragingival surface.

FIGS. 10A and 10B provide examples of healing abutments having alternative configurations of subgingival emergences in accordance with embodiments of the present disclosure.

FIGS. 11A and 11B provide examples of abutment screws in accordance with embodiments of the present disclosure.

FIGS. 12A-12C provide examples of healing abutments having a fully engaged abutment screw in accordance with embodiments of the present disclosure. FIG. 12A shows a cross-sectional view, FIG. 12B shows a transparent view, and FIG. 12C is a detail view of the head of the abutment screw forming a seal in the internal bore of the healing abutment.

FIGS. 13A and 13B provide cross-sectional views of healing abutments engaging the abutment screw in a retention position in accordance with embodiments of the present disclosure. FIG. 13A shows the screw threads engaging with the internal threads of the healing abutment. FIG. 13B depicts the screw a retained position which it can be carried to the patient or removed from the patient.

### DETAILED DESCRIPTION OF EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Described herein are anatomical healing abutments and dental implant systems including anatomical healing abutments that include abutments with different anatomical shapes corresponding to the shape of the cementoenamel junction in a corresponding natural tooth shape and different heights to provide for better healing based on the implant location and depth. The healing abutment is mounted to the implant shortly after the implant is placed and advantageously has a lower profile than surrounding teeth so that little to no load is placed on the implant from chewing while osseointegration occurs between the bone and the implant. The system allows for both digital scanning and/or impression tray molding of the healing abutment to determine the implant's location and alignment relative to surrounding teeth and gum tissue. The supragingival surface of the healing abutment may be roughened to improve scanning. The supragingival surface is the portion of the abutment that is above the gum of the patient when installed and corresponds to the occlusal orientation of a natural tooth. However, the supragingival surface sits lower than the occlusal surface of the neighboring teeth to prevent load bearing during healing, as described above.

In the system, at least one of the anatomical healing abutments includes features to help a practitioner easily visually select the correct abutment and size. The supragingival surface of the abutment may include visual markers that indicate information. For example, a first visual marking may be a notch or slot that may indicate an orientation for placement of the healing abutment in an oral cavity. In a particular embodiment, the first visual marking is a notch oriented to indicate a fixed position in the oral cavity, such as the buccal orientation. In other embodiments, the information may be information provided to the practitioner such as to select the intended abutment for installation from a kit of multiple abutments, identification of which type of abutment is installed, or identification of the height and/or shape of the abutment. A second visual marking may be used to indicate the size of the abutment. The second visual marking may be one or more dimples. The number or shape of the visual markers may convey additional information. Further visual indicators may also be included. The base of the abutment may be color-coded or laser marked to visually match the abutment to the corresponding implant receptacle. Other visual indicators can include a screw color or a pattern of markers on the connection portion.

Unlike other systems, the markers are not used in the digital scanning process to identify the orientation and location of the implant or abutment. Instead, the geometry of the 3D shapes of the different healing abutments are coded into a digital library of the dental CAD design software such that when the scanned healing abutment is identified, the location/alignment of the abutment is based on the known shapes in the digital library. In other words, the supragingival shape of the healing abutment itself is used digitally to detect implant location and/or orientation. In some embodiments, the 3D shapes can be asymmetrical.

Advantageously, the healing abutments provided herein can be integrated into digital restorative workflows. Because the healing abutments are already contoured to match natural tooth shapes, the tissue healing is more aesthetic and provides a better fit to the final prosthesis than do traditional abutments. The healing abutment can be scanned to transfer the implant position to a digital model; a separate scan body is not required, providing for fewer disturbances to the patient's healing tissues. Custom restorative abutments can be milled to match the anatomical profile of each healer to be delivered after healing and to maintain the tissue contouring with the final restoration.

According to example embodiments, the healing abutment comprises a prosthetic portion or anatomical portion 10 having a supragingival surface 12 at a first end integrally connected to a connection portion 20 at the opposite end, with side surfaces 14 and subgingival emergences 17 between the supragingival surface 12 and the connection portion 20. The connection portion 20 is configured for a close-fitting installation within a cooperating recess of a dental implant or implant analog. A conduit or bore 30 can be formed through the entirety of the abutment to allow a fastener or abutment screw to extend therethrough for securing the anatomical portion to the implant. According to example embodiments, the conduit extends entirely through the anatomical portion 10 from the supragingival surface 12 through the connection portion 20. The connection portion 20 can also comprise an implant contact portion 18 (or lower abutment surface) for butt-joint contact with the top face of the dental implant when placed in the patient's mouth (or correspondingly with an angular abutment contact surface of the implant analog).

The anatomical healing abutments can be provided in different anatomical profiles corresponding to the shape of the cementoenamel junction in a corresponding natural tooth. The anatomical healing abutments can be provided in more than one height to account for patient variability. In some embodiments, the anatomical healing abutments are provided in six different general anatomical profiles and two different heights for each profile, as shown in Table 1. Dental sites are described under the Universal Numbering System (also known as the American Numbering System). For example, a first anterior abutment shape, referred to as A1, is shaped for use at the location of a central maxillary incisor (sites 8, 9). A second anterior abutment shape, referred to as A2, is shaped for use at the location of a secondary (lateral) maxillary incisor or for central or lateral mandibular incisors (sites 7, 10, 23-26). A third abutment shape for median teeth, referred to as M1, is shaped for use at the location of a maxillary canine (sites 6, 11). A fourth abutment shape for median teeth, referred to as M2, is shaped for use at the location of a maxillary or mandibular premolar, or a mandibular canine (sites 4, 5, 12, 13, 20-22, 27-29). A fifth abutment shape for posterior teeth, referred to as P1, is shaped for use at the location of a maxillary molar (sites 2, 3, 14, 15). A sixth abutment shape for posterior teeth, referred to as P2, is shaped for use at the location of a mandibular molar (sites 18, 19, 30, 31).

TABLE 1

| Shape | Natural Tooth Type | Dental Site (UNS) |
|---|---|---|
| Anterior 1 (A1) | Maxillary Centrals | 8, 9 |
| Anterior 2 (A2) | Maxillary Laterals, | 7, 10, 23-26 |
| | Mandibular Incisors | |
| Mid 1 (M1) | Maxillary Canines | 6, 11 |
| Mid 2 (M2) | Premolars, Mandibular | 4, 5, 12, 13, |
| | Canines | 20-22, 27-29 |
| Posterior 1 (P1) | Maxillary Molars | 2, 3, 14, 15 |
| Posterior 2 (P2) | Mandibular Molars | 18, 19, 30, 31 |

Each of the six abutment shapes can be offered in various heights, for example, regular and tall heights. In some embodiments, the tall configurations are about 2 mm taller than the regular height for the A1, A2, M1, and M2 shapes and about 1.5 mm taller for the P1 and P2 shapes. The tall height abutments can have an additional height that is added at portion 17a of the subgingival emergences 17, but where the remaining dimensions are the same as in the regular height abutments.

The aforementioned connections 20 can have varying sizes and shapes that are designed to directly mate with a connection recess in an endosseous implant. Advantageously, the supragingival surfaces 12 of the healing abutments are scaled to have a footprint (e.g. overall abutment dimensions) that correspond to the size of the connection to closely mimic an individual patient's natural tooth size for optimal healing. For example, a healing abutment for placement in a maxillary canine position with a 3.0 mm connection portion will be smaller overall than a healing abutment for placement in a maxillary canine position with a 4.5 mm connection portion. The varying sizes and shapes can be offered individually to be selected by a clinician for a particular patient's need or can be provided in sets to provide clinicians with a large selection for use in practice.

The connection portion can be sized and shaped to cooperate with the recess in an endosseous implant. The connection portions are integrally formed with the anatomical portion of the healing abutments. In other words, the healing abutment including the connection portion, is formed as a single piece.

As mentioned above, the anatomical healing abutment includes a marking protocol in which visual markers are machined on the supragingival surface to help a practitioner easily visually identify the abutment size and height. In some embodiments, the marking protocol can include one or more dimple indicators on at least one healing abutment in the system, which can indicate the size of the connection portion and the corresponding recess in an endosseous implant. The marking protocol can also include a notch indicator. In particular embodiments, generally circular dimple indicators indicate the size of the abutment and notches indicate the height of the abutment. In a particular system, no dimple indicates a healing abutment sized for use with a 3.0 mm connection, one dimple indicates use with a 3.5 mm connection, two dimples indicates use with a 4.5 mm connection, and three dimples indicates use with a 5.7 mm connection. In another example, one dimple indicates a healing abutment sized for use with a 2.5 mm connection, and two dimples indicates use with a 2.7 mm connection. The position of the dimples on the supragingival surface can be variable, while the notch position is fixed. Other shapes and sizes of visual markings can be envisioned by one having ordinary skill in the art, such as raised dots, ridges, or other raised or recessed shapes.

The machined notch visual markers on the supragingival surface are used as a means to visually assist the clinician in orienting the healing abutment. For example, in a properly seated position, the most external end of the notch will be perpendicular to the buccal plane (or labial plane for incisal healers), providing confirmation to the clinician that the healing abutment is installed correctly. Advantageously, the notches can secondarily be used to indicate regular or tall height of the healing abutment. For example, a single notch (or an I-shaped notch) indicates a regular height healing abutment. A T-shaped notch indicates a tall height healing abutment.

Other visual markers could be used to convey size, shape, and/or height information. For example, rings etched on the supragingival surface of the anatomical portion could be used to indicate information based on the number or shape of the rings. Markers could be machined in other locations, such as the labial or buccal surfaces of the anatomical portion.

In some embodiments, the connection portion 20 of each healing abutment is oriented such that every healing abutment having the same connection portion will connect with a dental implant in a pre-determined orientation. The connection portion 20 can include an alignment feature that ensures that the healing abutment is properly positioned when engaged with the dental implant. The first visual indicator (such as a notch) is oriented to the alignment feature to provide visual confirmation to the clinician that the healing abutment is correctly oriented in the mouth. For example, in a connection portion 20 having a hexagonal (hex) profile, a flat portion of the hex connection serves as an alignment feature. The flat portion is oriented so that the abutment seats into a corresponding flat portion of the implant. The notch indicator is in line with the alignment feature. This allows the abutment to be seated into the implant in the correct orientation relative to adjacent anatomy in the oral cavity and the notch (when facing toward the buccal plane) provides a visual confirmation to the clinician. Advantageously, when the anatomical shape of the abutment is used in the CAD workflow (described above), the orientation of the implant internal features is thereby known. In other embodiments, the alignment feature could be slots, cams, or other anti-rotational features present in the internal recess of the corresponding implant. The alignment features are consistently placed on every abutment in the system.

The anatomical healing abutments can therefore be provided in dozens of combinations of sizes and heights, as shown in Table 2. The mesial-distal and buccal-lingual distances indicate the width of the supragingival surface at the widest point. The abutment height indicates the subgingival emergence 17 height for a regular height abutment; tall height abutments can have the indicated height added at 17a between the anatomical profile and the connection portion 20. Each of the connection portion sizes can be provided in a connection size and geometry that corresponds to the recess in an endosseous implant. For example, the A1 shape for use at the location of a maxillary incisor can be provided in such as 3.0 mm regular, 3.0 mm tall, 3.5 mm regular, 3.5 mm tall, 4.5 mm regular, 4.5 mm tall, etc. In another example, the M1 shape for use at the location of a maxillary canine can be provided in such as 3.0 mm regular, 3.0 mm tall, 3.5 mm regular, 3.5 mm tall, 4.5 mm regular, 4.5 mm tall, 5.7 regular, and 5.7 mm tall. Each of the anatomical shapes can be provided in various sizes and/or heights according to need.

TABLE 2

| | | | | | Additional |
|---|---|---|---|---|---|
| | | | | | Height |
| | | | | Abutment | (between |
| | | | | Height | anatomical |
| | | Abutment | Abutment | (anatomical | profile and |
| Shape | Anatomical | mesial- | Buccal- | profile | implant |
| Name | Shape | Distal* | Lingual* | section) | connector) |
| Anterior | Rounded | 3 mm to | 4 mm to | 2 mm to | 0 mm to |
| 1 | pentagon | 6.5 mm | 6 mm | 6 mm | 5 mm |
| Anterior | Rounded | 3.5 mm to | 4 mm to | 2 mm to | 0 mm to |
| 2 | ovoid | 5.5 mm | 6 mm | 6 mm | 5 mm |
| Mid 1 | Rounded | 4 mm to | 4 mm to | 2 mm to | 0 mm to |
| | diamond | 6 mm | 6.5 mm | 6 mm | 5 mm |
| Mid 2 | Oval | 4 mm to | 5 mm to | 2 mm to | 0 mm to |
| | | 6.5 mm | 8 mm | 6 mm | 5 mm |
| Poste- | Rounded | 6 mm to | 6.5 mm to | 2 mm to | 0 mm to |
| rior 1 | rectangle | 11 mm | 11.5 mm | 6 mm | 5 mm |
| | (B/L longer | | | | |
| | than M/D) | | | | |
| Poste- | Rounded | 6.5 mm to | 5.5 mm to | 2 mm to | 0 mm to |
| rior 2 | rectangle | 11.5 mm | 10.5 mm | 6 mm | 5 mm |
| | (M/D longer | | | | |
| | than B/L) | | | | |

Abutment dimensions are taken at the widest points.

The healing abutment can include color-coding to match the connection on the dental implant. In various embodiments, the color coding is a titanium-anodized surface colored to match the corresponding prosthetic platform, for easy visual identification. In particular embodiments, the colored surface is on the connection portion. In addition to or instead of the connection coloring, the visual markers on the supragingival surface may be color coded. In yet other embodiments, the anatomical portion surface or the entire healing abutment or portions thereof could be color coded, such as through dipping.

The healing abutments are made from a biocompatible material suitable for use in an oral environment. In particular embodiments, the healing abutments are manufactured from a medical grade Titanium alloy (e.g., Ti-6Al-4V titanium alloy per ASTM F136). In other embodiments, the healing abutments may be comprised of polyether ether ketone (PEEK) or other suitable polymer. Other biocompatible metals, alloys, or polymers could be used as envisioned by one having ordinary skill in the art.

In some embodiments, the healing abutment or parts thereof has been subjected to a surface modification to improve the scannability of the healing abutment. In a particular embodiment, the supragingival surface of the healing abutment is subjected to a bead blasting process to create a matte surface suitable for scanning. The surface modification can occur after anodization. In other embodiments, the surface modifications can include such as laser marking, acid etching, tumbling, coating, or other process that creates a matte surface.

As described above, the healing abutments are designed to be connected to the implant during the healing period between implant placement and final abutment placement (e.g. prosthetic tooth placement). The healing abutments are connected to the implant using an abutment screw. The tapered internal bore of the healing abutment can include internal threads (also referred to as retention threads) such that the abutment can be carried to the mouth with the screw retained within the abutment. Advantageously, these internal retention threads keep the screw engaged with the healing abutment during placement and removal, thereby simplifying the procedure for the practitioner. In some embodiments, the threads are UNF 1-72 threads. The screws can be provided in multiple heights to correspond with multiple healing abutment heights. By providing multiple screw heights that correspond with the different abutment heights, the screw head sits very near the supragingival surface of the healing abutment. This is desirable because in a system having only one screw height for more than one abutment height, the screw head may be recessed below the supragingival surface of the abutment, thereby allowing food and other contaminants to become trapped in the recess. In particular embodiments, the abutment screws are provided in regular and tall lengths to mate with the regular and tall height healing abutments, respectively. Advantageously, the screw does not require a cap. The screw has a tapered top portion such that when the screw is installed in the abutment, the screw head seals off the abutment screw channel (internal bore) of the abutment, preventing the ingress of contaminants into the implant. In other embodiments, the bore may not be tapered and could be sealed with an o-ring or other sealing method.

Also provided herein are methods for using the healing abutments for impressions. The healing abutments can be used in conjunction with digital or tray impression protocols for final prosthetic design. For both digital and tray impressions, the appropriate healing abutment is selected based on the implant size and location, then the healing abutment is seated into the implant with the supragingival notch perpendicular to the buccal plane and then hand-tightened. Approximately 0.5 mm of the supragingival surface of the healing abutment should be visible above the soft tissue. Optionally, a radiograph can be taken along the long axis of the implant to ensure proper seating of the healing abutment in the connection of the implant. For digital impressions, the healing abutment can be scanned with an intraoral scanner by a dental professional. The matte finish of the supragingival surface allows for reduced scanning artifacts. For tray impressions, a closed-tray impression can be taken by a dental professional. The impression can be poured into a stone model and then the stone model can be scanned with a dental desktop/lab scanner. In both digital and tray impression workflows, the resulting scan can then be used in dental CAD software to digitally locate the placement of the implant in relation to the patient's oral cavity for digital design of a final prosthetic. Identification of the healing abutment in digital scans is accomplished by an encoding of the 3D geometric shape of the healing abutment in a digital library and matching alignment of the scan to the digital library. The pattern of dimples and notches machined into the supragingival surface of each healing abutment design are not used in this stage. In other words, the dimple indicators and the notch indicators are not used for digital scanning location or orientation purposes.

Also provided are methods of selecting an appropriate abutment from the abutment system for use in a patient. The method can include determining the connection shape and size of a dental implant installed in a patient's oral cavity. The practitioner can select a healing abutment having an anatomical shape corresponding to the CEJ of the patient's natural tooth (e.g. an A1 abutment at the location of an upper central incisor). The practitioner can select the appropriate connection size and/or geometry using a visual indicator, such as the number of dimples on the supragingival portion of the abutment and/or color coding that corresponds to the dental implant. Based on the patient's anatomy, the practitioner can determine whether a regular height or a tall height abutment is needed. The practitioner can select an abutment height using the notch indicator. The method can further include installing an implant and mounting the selected abutment to the implant. The mounting can include aligning the abutment to the correct anatomical orientation using the alignment feature and/or the buccal notch. The method can further include scanning or impression molding the mounted abutment and surrounding anatomy. The method can include allowing a sufficient healing time, preparing a permanent prosthesis based on the scan or impression molding, removing the abutment, and installing the permanent prosthesis. As can be appreciated by a person having ordinary skill in the art, the practitioner could select the abutment features in any order of the steps.

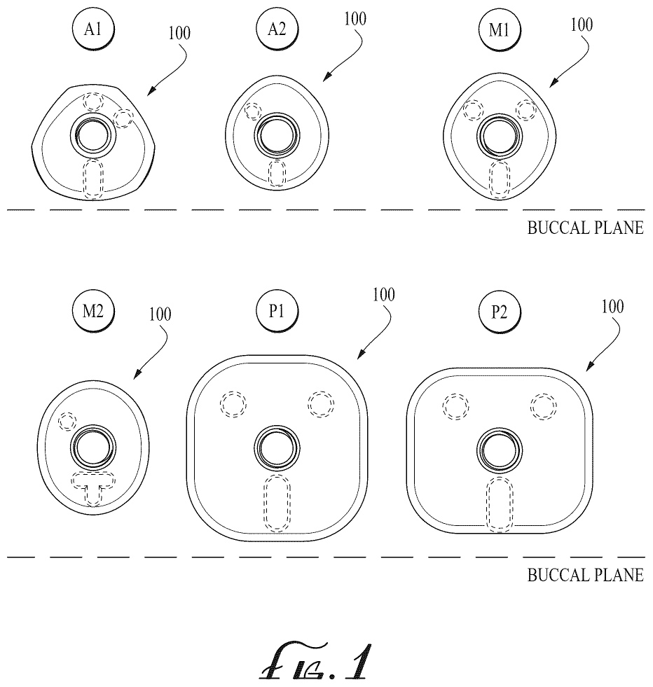

With reference now to the drawing figures, wherein like reference numbers represent corresponding parts throughout the several views, FIG. 1 provides example embodiments of the six healing abutment shapes described herein, shown in an occlusal (top) view. The top row, left to right, shows an example of A1, A2, and M1 healing abutments. The bottom row, left to right, shows an example of a M2, P1, and P2 healing abutments. The notch indicator is oriented perpendicular to the buccal plane, indicated by the line in the figure. As described above, the shape of the notch indicator provides a visual identifier to the clinician regarding the abutment height. An I-shaped notch indicator, shown on the A1, A2, M1, P1, and P2 abutments, indicates a regular height healing abutment. A T-shaped indicator, shown on the M2 abutment, indicates a tall height healing abutment. Varying dimple numbers and patterns can be used to indicate the size of the connector and the corresponding anatomical portion size, as described above.

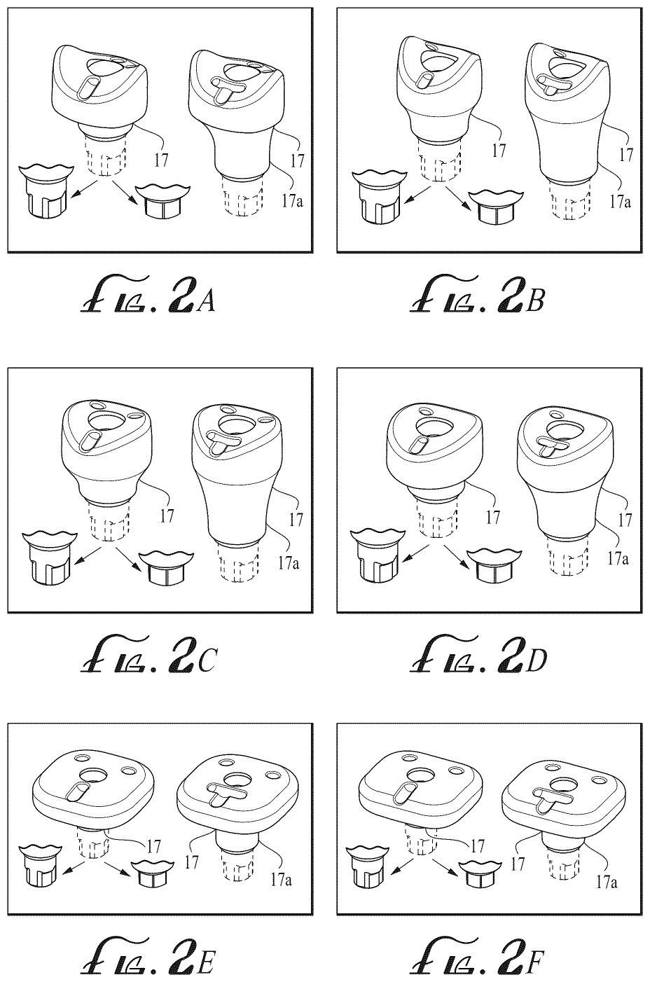

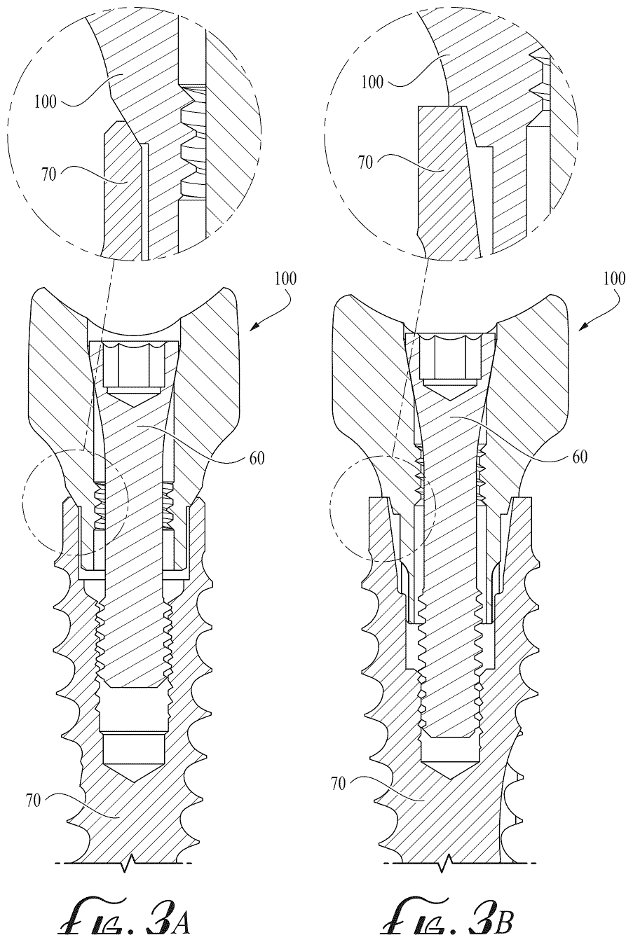

FIGS. 2A-2F provide perspective views of example embodiments of the six healing abutment shapes, depicted in regular and tall heights for each shape. Shown are (top row, left to right) A1, A2, (middle row, left to right) M1 and M2 abutments and (bottom row, left to right) P1, and P2 abutments. Regular height abutments are indicated by an I-shaped indicator notch and tall height abutments are indicated by a T-shaped indicator notch. The dimensions of the regular and tall height abutments for a given connection size are identical with the exception of added height along a straight portion 17a of the subgingival emergences 17 in the tall height variations.

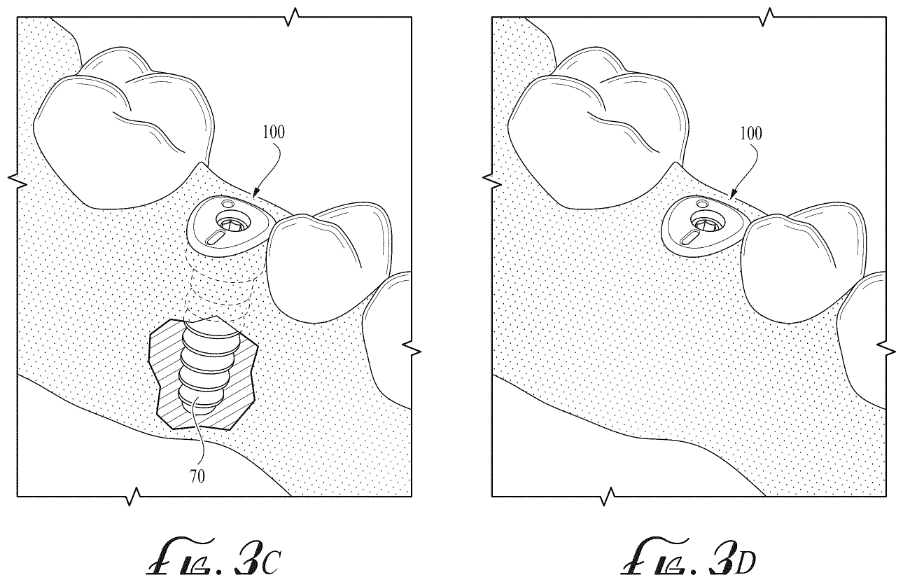

FIGS. 3A-3D provide various views of example healing abutments installed into a dental implant. FIG. 3A shows one embodiment of a healing abutment, where the healing abutment 100 is configured to seat in an internal recess of the dental implant 70, such that implant contact portion 18 has a tapered fit within the implant 70, as indicated by the detail view. Screw 60 is mated in the internal threads of implant 70. FIG. 3B shows another embodiment of a healing abutment 100 configured to seat atop the dental implant 70 when mated together by screw 60, such that implant contact portion 18 forms a butt joint with implant 70. FIGS. 3C and 3D show the healing abutment 100 installed in a dental implant 70 in a patient's oral cavity.

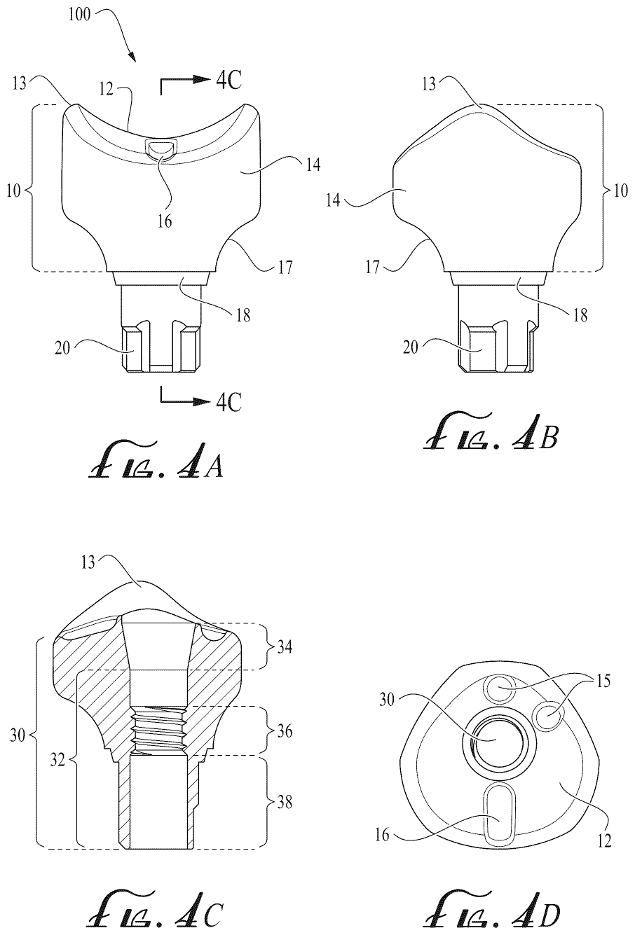

FIGS. 4A-4D provide an example embodiment of an A1 healing abutment 100 for use in the position of a maxillary central incisor. FIG. 4A is a side view from the buccal side. FIG. 4B is a mesial view. FIG. 4C is a cross-sectional view through the 4C-4C plane shown in FIG. 4A. FIG. 4D is a top view showing the supragingival surface.

As can be seen from the several views, the anatomical portion 10 has a relatively straight profile along the side surfaces 14, where the anatomical portion 10 does not taper or bow outwardly along the side surfaces 14 from the supragingival surface 12. In the depicted embodiment, the mesial and distal heights of the anatomical portion are the same as one another, and the buccal and lingual heights are the same as one another. However, in some embodiments, the mesial and distal heights could be different from one another. The mesial and distal heights should be greater than the buccal and lingual heights. The anatomical portion 10 includes gingival margin peaks 13 at the interdental contacts. The delta or curve profile of the mesial and distal gingival margin peaks 13 of the anatomical portion can be varied. Shown in this example, the curve of the mesial and distal gingival margin peaks 13 is asymmetrical from an axis running through the central bore 30 of the abutment. The supragingival surface has a concave profile from the buccal and lingual views. The concave shape follows the gingival contour so that less of the healing abutment is visible when it is in place than with a non-concave supragingival surface 12. This hyperbolic paraboloid supragingival shape also allows for a more natural appearing temporary bridge to be placed above the healing abutment. In the occlusal view, the anatomical portion 10 has a rounded, generally pentagonal shape, with the base of the pentagon oriented along the buccal plane.

The subgingival emergences 17 are shown as concave from the transition from the side surfaces 14 to the connection portion 20. However, the subgingival emergences 17 can alternatively be straight or convex depending on the implant connection as can be envisioned by one having ordinary skill in the art.

The shown embodiment has an implant connection portion 20 with a 2.7 mm diameter, however the healing abutment can be provided in other sizes and connection portion types as described herein to allow for healing abutments compatible with a desired implant. The size of the shown embodiment is indicated by two dimples 15, where other sizes would be indicated by other dimple numbers. The shown embodiment is a regular height abutment, indicated by an I-shaped notch indicator 16. A tall height abutment would be indicated by a T-shaped indicator.

The central bore 30 contains internal threads 36 (e.g., M1.6×0.35) that mate with a compatible abutment screw. The depicted embodiment is a regular height anatomical portion 10, having a shaft portion 32 of the central bore 30 and tapered screw head portion 34. In embodiments having regular and tall height variants with the same connection type, the heights of the central bore 30 below the threads is the same. In other words, the dimensions of lower portion 38 and internal threads 36 are the same and any additional height of central bore 30 is added above the internal threads 36. The additional height of the anatomical portion 10 in a tall variation is added by including a straight portion 17a (not shown) at the lower end of the subgingival emergences 17 such that the portion of the central bore above the threads is longer than in the regular height embodiment.

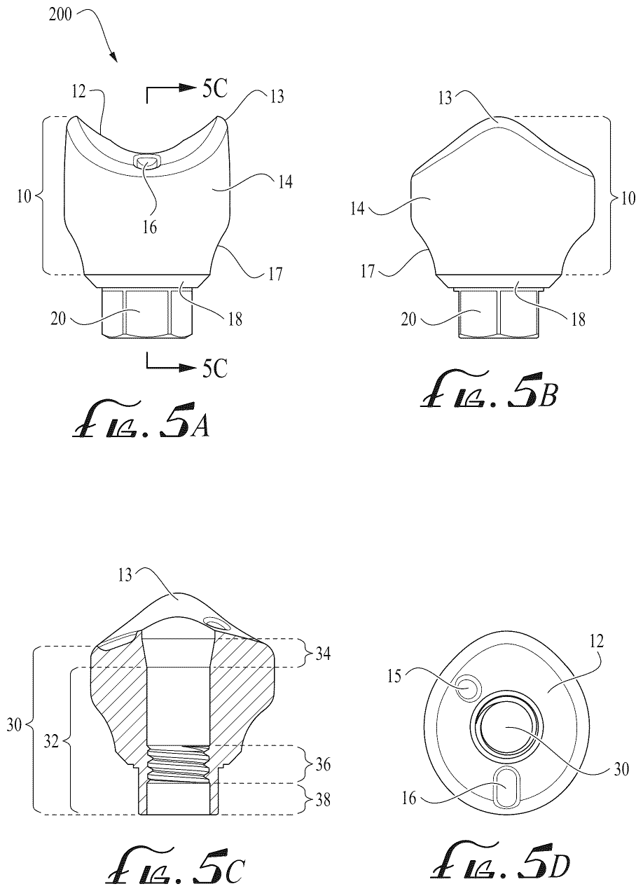

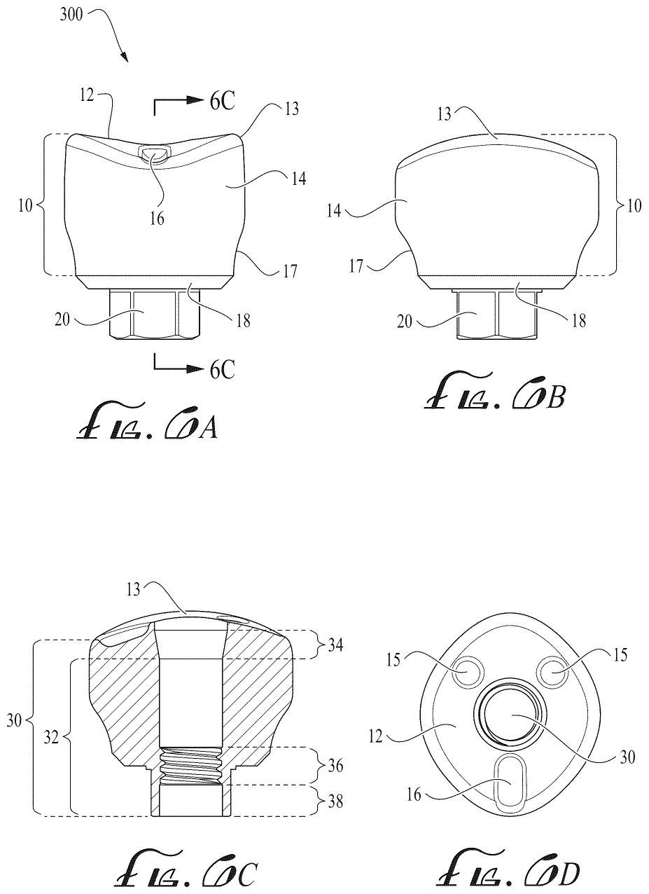

FIGS. 5A-5D show several views of an embodiment of an A2 healing abutment 200 for use in the position of a maxillary lateral incisor or mandibular incisor. FIG. 5A is a side view from the buccal side. FIG. 5B is a mesial view. FIG. 5C is a cross-sectional view through the 5C-5C plane shown in FIG. 5A. FIG. 5D is a top view showing the supragingival surface 12.

As can be seen from the several views, the anatomical portion 10 has a relatively straight profile along the side surfaces 14, where the anatomical portion 10 does not taper or bow outwardly along the side surfaces 14 from the supragingival surface 12. In some embodiments, the depicted mesial and distal heights of the anatomical portion are the same as one another, and the buccal and lingual heights are the same as one another. In other embodiments, the mesial and distal heights could be different from one another. Like the A1 shape, the mesial and distal heights should be greater than the buccal and lingual heights. The anatomical portion 10 includes gingival margin peaks 13 at the interdental contacts, forming a hyperbolic paraboloid supragingival surface. The delta or curve profile of the mesial and distal gingival margin peaks 13 of the anatomical portion can be varied. Shown in this example, the curve of the mesial and distal gingival margin peaks 13 is asymmetrical from an axis running through the central bore 30 of the abutment. The supragingival surface 12 of the A2 abutment has a concave profile from the buccal and lingual views. In the occlusal view, the anatomical portion 10 has a rounded, generally ovoid shape, with the largest radius of the egg shape oriented along the buccal plane.

The subgingival emergences 17 are shown as concave from the transition from the supragingival surface 12 to the connection portion 20. However, the subgingival emergences 17 can be straight or convex as can be envisioned by one having ordinary skill in the art.

The shown embodiment has a connection portion 20 that can be variable based on the desired implant compatibility. A 3.5 mm diameter connection portion 20 is depicted as a non-limiting example. The size of the shown embodiment is indicated by a single dimple 15, where other sizes would be indicated by other dimple numbers. The shown embodiment is a regular height abutment, indicated by an I-shaped notch indicator 16. A tall height abutment would be indicated by a T-shaped notch.

The central bore 30 contains internal threads 36 (e.g., UNF 1-72 class 2B) that mate with a compatible abutment screw. The depicted embodiment is a regular height anatomical portion 10, having a shaft portion 32 of the central bore 30 and tapered screw head portion 34. In embodiments having regular and tall height variants with the same connection type, the heights of the central bore 30 below the threads is the same. In other words, the dimensions of lower portion 38 and internal threads 36 are the same and any additional height of central bore 30 is added above the internal threads 36. The additional height of the anatomical portion 10 in a tall variation is added by including a straight portion 17a (not shown) at the lower end of the subgingival emergences 17 such that the portion of the central bore above the threads is longer than in the regular height embodiment.

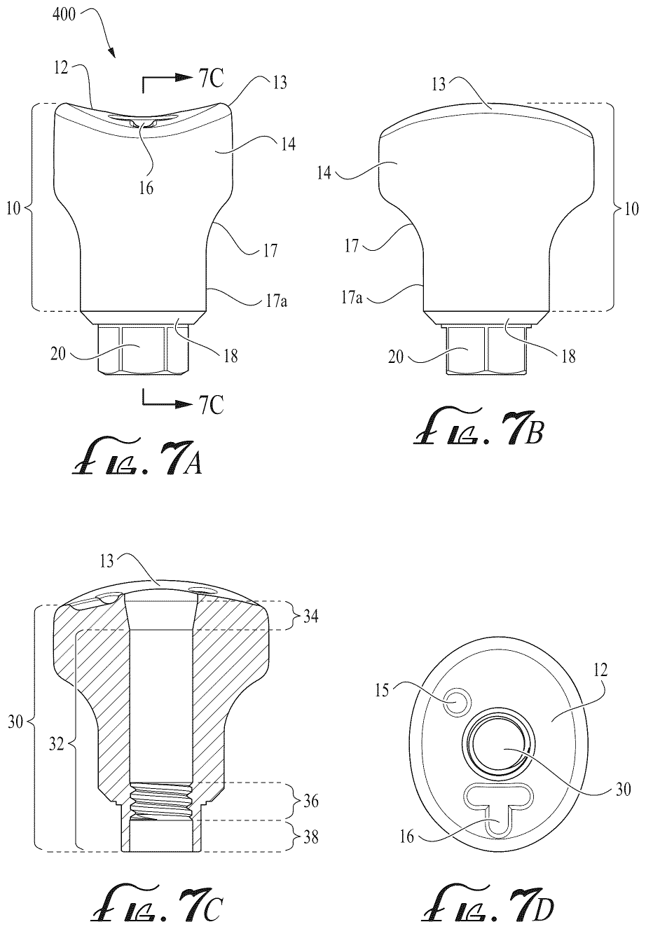

FIGS. 6A-6D show several views of an embodiment of an M1 healing abutment 300 for use in the position of a maxillary canine. FIG. 6A is a side view from the buccal side. FIG. 6B is a mesial view. FIG. 6C is a cross-sectional view through the 6C-6C plane shown in FIG. 6A. FIG. 6D is a top view showing the supragingival surface 12.

As can be seen from the several views, the anatomical portion 10 has a relatively straight profile along the side surfaces 14, where the anatomical portion 10 does not taper or bow outwardly along the side surfaces 14 from the supragingival surface 12. The mesial and distal heights of the anatomical portion are the same as one another, and the buccal and lingual heights are the same as one another. Like the A1 shape, the mesial and distal heights should be greater than the buccal and lingual heights. The anatomical portion 10 includes gingival margin peaks 13 at the interdental contacts. The delta or curve profile of the mesial and distal gingival margin peaks 13 of the anatomical portion can be varied. Shown in this example, the curve of the mesial and distal gingival margin peaks 13 is symmetrical from an axis running through the central bore 30 of the abutment. The supragingival surface 12 of the M1 abutment has a concave profile from the buccal and lingual views. In the occlusal view, the anatomical portion 10 has a rounded, generally diamond shape. The mesial-distal length is slightly shorter than the buccal-lingual length.

The subgingival emergences 17 are shown as concave from the transition from supragingival surface 12 to the connection portion 20. However, the subgingival emergences 17 can be straight or convex, depending on the implant connection type, as can be envisioned by one having ordinary skill in the art.

The shown embodiment has a connection portion 20 that can be variable based on the desired implant compatibility. A 3.5 mm diameter connection portion 20 is depicted as a non-limiting example. The size of the shown embodiment is indicated by two dimples 15, where other sizes would be indicated by other dimple numbers. The shown embodiment is a regular height abutment, indicated by an I-shaped notch indicator 16. A tall height abutment would be indicated by a T-shaped notch.

The central bore 30 contains internal threads 36 (e.g., UNF 1-72 class 2B) that mate with a compatible abutment screw. The depicted embodiment is a regular height anatomical portion 10, having a shaft portion 32 of the central bore 30 and tapered screw head portion 34. In embodiments having regular and tall height variants with the same connection type, the heights of the central bore 30 below the threads is the same. In other words, the dimensions of lower portion 38 and internal threads 36 are the same and any additional height of central bore 30 is added above the internal threads 36. The additional height of the anatomical portion 10 in a tall variation is added by including a straight portion 17a (not shown) at the lower end of the subgingival emergences 17 such that the portion of the central bore above the threads is longer than in the regular height embodiment.

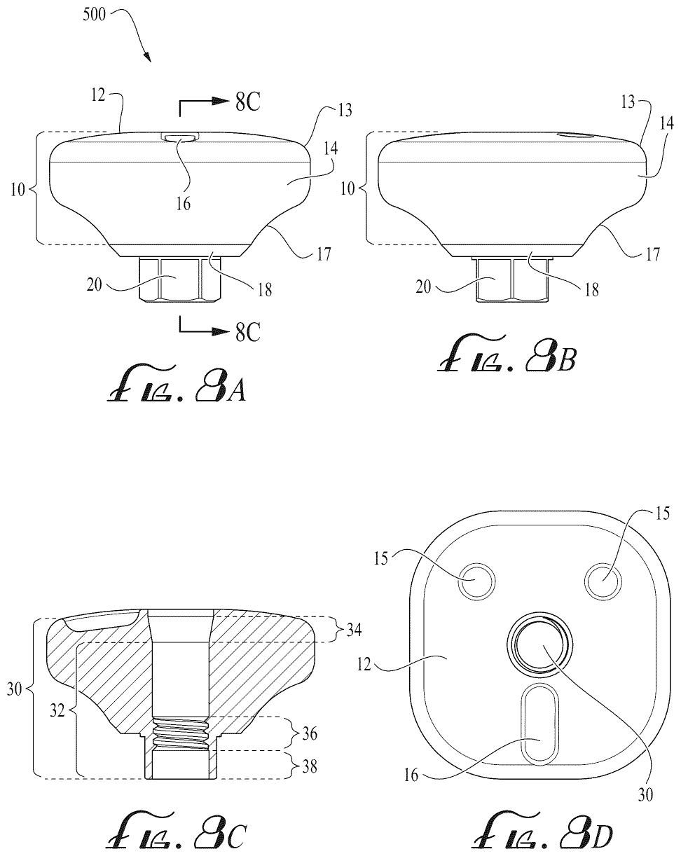

FIGS. 7A-7D show several views of an embodiment of an M2 healing abutment 400 for use in the position of a premolar or mandibular canines. FIG. 7A is a side view from the buccal side. FIG. 7B is a mesial view. FIG. 7C is a cross-sectional view through the 7C-7C plane shown in FIG. 7A. FIG. 7D is a top view showing the supragingival surface 12.

As can be seen from the several views, the anatomical portion 10 has a relatively straight profile along the side surfaces 14, where the anatomical portion 10 does not taper or bow outwardly along the side surfaces 14 from the supragingival surface 12. The mesial and distal heights of the anatomical portion are the same as one another, and the buccal and lingual heights are the same as one another. Like the M1 shape, the mesial and distal heights should be greater than the buccal and lingual heights. The anatomical portion 10 includes gingival margin peaks 13 at the interdental contacts. The delta or curve profile of the mesial and distal gingival margin peaks 13 of the anatomical portion can be varied. Shown in this example, the curve of the mesial and distal gingival margin peaks 13 is symmetrical from an axis running through the central bore 30 of the abutment. The supragingival surface 12 of the M2 abutment has a concave profile from the buccal and lingual views. In the occlusal view, the anatomical portion 10 has a rounded, generally oval shape. The mesial-distal length is slightly shorter than the buccal-lingual length.

The subgingival emergences 17 are shown as concave from the transition from the supragingival surface 12 to the connection portion 20. However, the subgingival emergences 17 can be straight or convex, depending upon the implant connection type, as can be envisioned by one having ordinary skill in the art.

The shown embodiment has a connection portion 20 that can be variable based on the desired implant compatibility. A 3.5 mm diameter connection portion 20 is depicted as a non-limiting example. The size of the shown embodiment is indicated by a single dimple 15, where other sizes would be indicated by other dimple numbers. The shown embodiment is a tall height abutment, indicated by a T-shaped notch indicator 16. A regular height abutment would be indicated by an I-shaped notch.

The central bore 30 contains internal threads 36 (e.g., UNF 1-72 class 2B) that mate with a compatible abutment screw. The depicted embodiment is a tall height anatomical portion 10, having a shaft portion 32 of the central bore 30 and tapered screw head portion 34. In embodiments having regular and tall height variants with the same connection type, the heights of the central bore 30 below the threads is the same. In other words, the dimensions of lower portion 38 and internal threads 36 are the same and any additional height of central bore 30 is added above the internal threads 36. The additional height of the anatomical portion 10 in a tall variation is added by including a straight portion 17a at the lower end of the subgingival emergences 17 such that the portion of the central bore above the threads is longer than in the regular height embodiment.

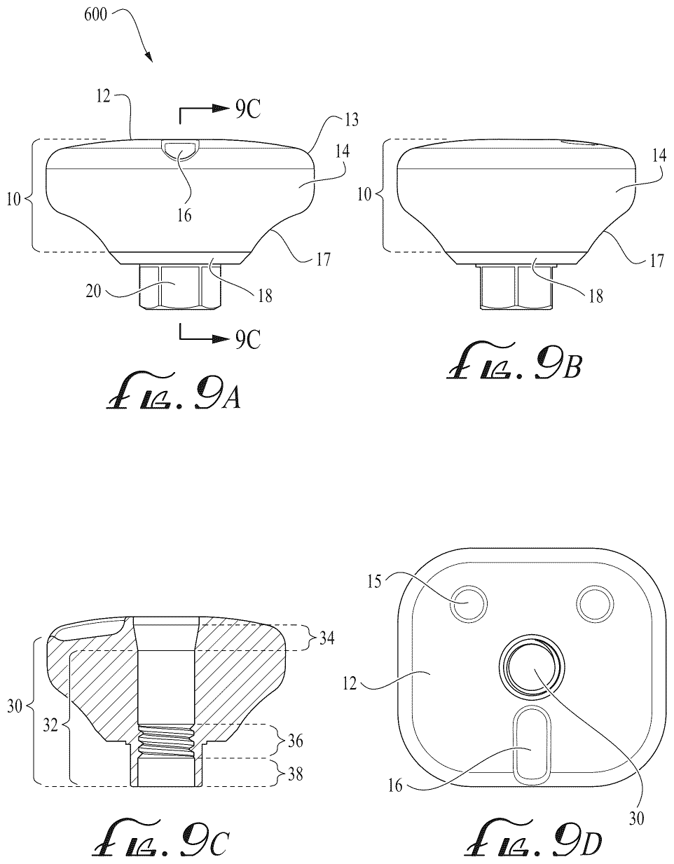

FIGS. 8A-8D show several views of an embodiment of a P1 healing abutment 500 for use in the position of a maxillary molar. FIG. 8A is a side view from the buccal side. FIG. 8B is a mesial view. FIG. 8C is a cross-sectional view through the 8C-8C plane shown in FIG. 8A. FIG. 8D is a top view showing the supragingival surface 12.

As can be seen from the several views, the anatomical portion 10 has a relatively straight profile along the side surfaces 14, where the anatomical portion 10 does not taper or bow outwardly along the side surfaces 14 from the supragingival surface 12. The supragingival surface 12 has a constant height along the entire perimeter. The supragingival surface 12 of the P1 abutment has a convex profile from the perimeter to the top-most center of the part. In the occlusal view, the anatomical portion 10 has a rounded, generally rectangular shape. The mesial-distal length is slightly shorter than the buccal-lingual length.

The subgingival emergences 17 are shown as concave from the transition from the anatomical portion 10 to the connection portion 20. However, the subgingival emergences 17 can be straight or convex as can be envisioned by one having ordinary skill in the art.

The shown embodiment has a connection portion 20 that can be variable based on the desired implant compatibility. A 4.5 mm diameter connection portion 20 is depicted as a non-limiting example. The size of the shown embodiment is indicated by two dimples 15, where other sizes would be indicated by other dimple numbers. The shown embodiment is a regular height abutment, indicated by an I-shaped notch indicator 16. A tall height abutment would be indicated by a T-shaped notch.

The central bore 30 contains internal threads 36 (e.g., UNF 1-72 class 2B) that mate with a compatible abutment screw. The depicted embodiment is a regular height anatomical portion 10, having a shaft portion 32 of the central bore 30 and tapered screw head portion 34. In embodiments having regular and tall height variants with the same connection type, the heights of the central bore 30 below the threads is the same. In other words, the dimensions of lower portion 38 and internal threads 36 are the same and any additional height of central bore 30 is added above the internal threads 36. The additional height of the anatomical portion 10 in a tall variation is added by including a straight portion 17a (not shown) at the lower end of the subgingival emergences 17 such that the portion of the central bore above the threads is longer than in the regular height embodiment.

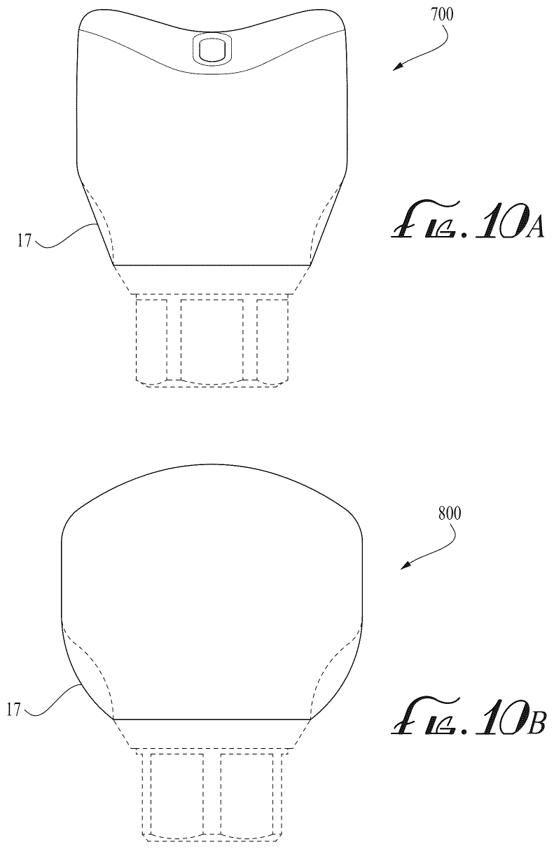

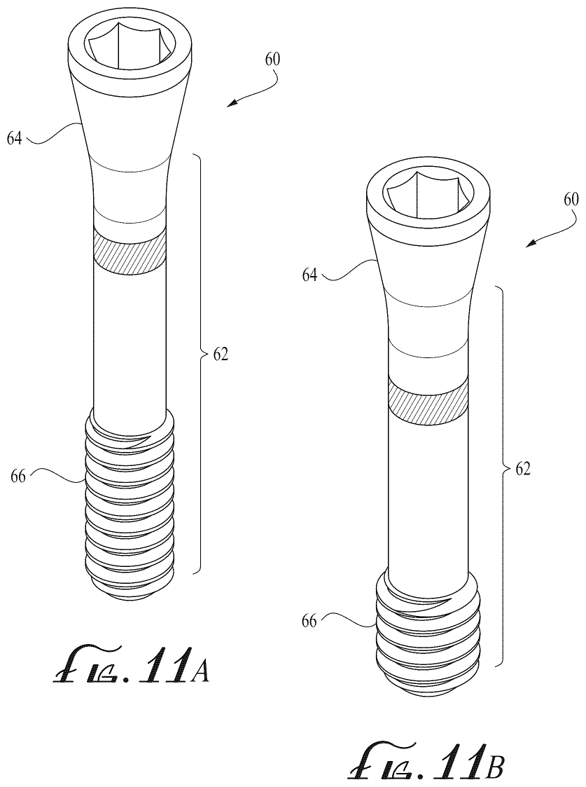

FIGS. 9A-9D show several views of an embodiment of a P2 healing abutment 600 for use in the position of a mandibular molar. FIG. 9A is a side view from the buccal side. FIG. 9B is a mesial view. FIG. 9C is a cross-sectional view through the 9A-9A plane shown in FIG. 9A. FIG. 9D is a top view showing the supragingival surface 12.

As can be seen from the several views, the anatomical portion 10 has a relatively straight profile along the side surfaces 14, where the anatomical portion 10 does not taper or bow outwardly along the side surfaces 14 from the supragingival surface 12. The supragingival surface 12 has a constant height along the entire perimeter. The supragingival surface 12 of the P1 abutment has a convex profile from the perimeter to the top-most center of the part. In the occlusal view, the anatomical portion 10 has a rounded, generally rectangular shape. The mesial-distal length is slightly longer than the buccal-lingual length, whereas the P1 shape is shorter along the mesial distal length.

The subgingival emergences 17 are shown as concave from the transition from the anatomical portion 10 to the connection portion 20. However, the subgingival emergences 17 can be straight or convex as can be envisioned by one having ordinary skill in the art.

The shown embodiment has a connection portion 20 that can be variable based on the desired implant compatibility. A 4.5 mm diameter connection portion 20 is depicted as a non-limiting example. The size of the shown embodiment is indicated by two dimples 15, where other sizes would be indicated by other dimple numbers. The shown embodiment is a regular height abutment, indicated by an I-shaped notch indicator 16. A tall height abutment would be indicated by a T-shaped notch.

The central bore 30 contains internal threads 36 (e.g., UNF 1-72 class 2B) that mate with a compatible abutment screw. The depicted embodiment is a regular height anatomical portion 10, having a shaft portion 32 of the central bore 30 and tapered screw head portion 34. In embodiments having regular and tall height variants with the same connection type, the heights of the central bore 30 below the threads is the same. In other words, the dimensions of lower portion 38 and internal threads 36 are the same and any additional height of central bore 30 is added above the internal threads 36. The additional height of the anatomical portion 10 in a tall variation is added by including a straight portion 17a (not shown) at the lower end of the subgingival emergences 17 such that the portion of the central bore above the threads is longer than in the regular height embodiment.

As described above in reference to previous figures, the healing abutments can vary at the subgingival emergences 17. FIGS. 10A and 10B provide examples of alternative configurations of subgingival emergences 17 of healing abutments 700 and 800, respectively. FIG. 10A shows an example of straight subgingival emergences 17, in which the subgingival emergences 17 extend from side surfaces 14 to implant contact portion 18 without curving inwardly or outwardly. FIG. 10B shows an example of convex subgingival emergences 17, in which the subgingival emergences 17 extend outwardly from side surfaces 14 to implant contact portion 18, forming slightly bulbous subgingival emergences 17.

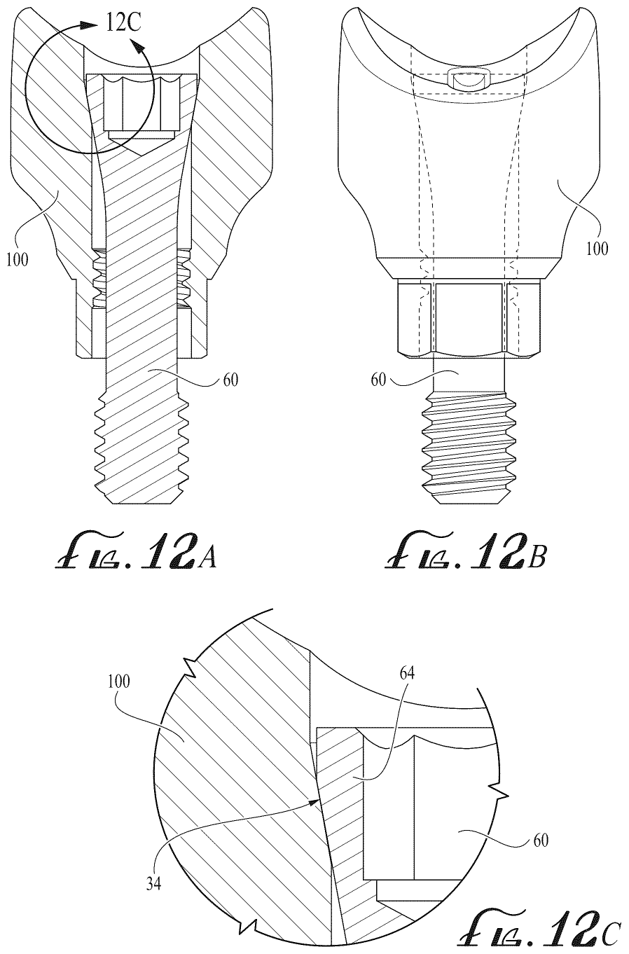

FIGS. 11A and 11B provide examples of abutment screws 60. FIG. 11A shows an example of an abutment screw 60 that is compatible with healing abutments having a first connection portion 20 shape and FIG. 11B shows an example of an abutment screw 60 that is compatible with healing abutments having a second connection portion 20 shape. When installed in the healing abutment, the thread portion 66 mates with the internal threads on a dental implant to secure the healing abutment to the dental implant (e.g., M1.6 threads). Tapered screw head 64 seats in the tapered portion of the internal bore of the healing abutment, forming a seal within the internal bore 30 to prevent ingress of contaminants or moisture into the dental implant. The depicted embodiment is a tall height abutment screw 60. A regular height screw has a shaft 62 length that is shorter. The regular and tall height abutment screws are the same dimensions with the exception of the shaft 62 length, where the length difference is along the portion of the shaft 62 between thread portion 66 and angled screw head 64. FIG. 11B is an example of an abutment screw 60 that is compatible with healing abutments having a connection portion 20 compatible with a different dental implant (e.g., having UNF-172 threads). The tall height is shown. As described in reference to FIG. 11A, all of the dimensions of screws are the same for tall and regular height screws except the shaft 62 heights. In the depicted embodiment, tall screws have a laser marked band as depicted by the shaded area, while regular length screws do not. In some embodiments, the screws compatible with the first connection shape can include color-coded anodization (e.g., blue) while the screws compatible with the second connection shape are not anodized to assist a practitioner in visually selecting the appropriate screw for the compatible connection type. In other embodiments, the color coding can be a different color or applied to different screw types, as can be appreciated by a person having ordinary skill in the art.

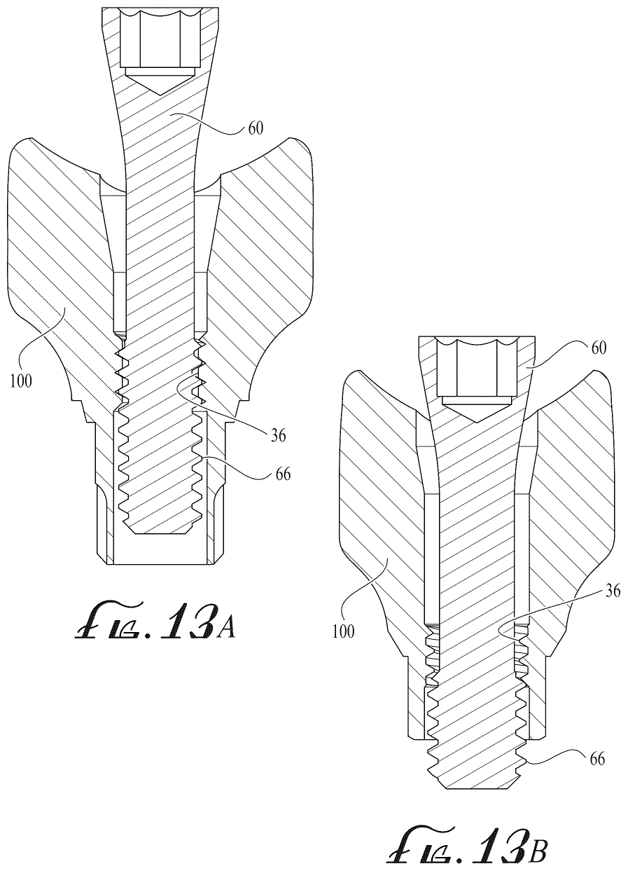

FIGS. 12A-12C provide examples of healing abutments 100 having a fully engaged abutment screw 60. FIG. 12A shows a cross-sectional view, FIG. 12B shows a transparent view. As can be appreciated from the figures, when in the fully engaged position, the screw head 64 is flush or substantially flush with the lowest point of the supragingival surface of the healing abutment, and the screw threads extend below the connection portion to engage with the internal threads 36 of a dental implant (as seen in FIGS. 3A-3B). FIG. 12C is a detail view of the head 64 of the abutment screw forming a seal in the tapered portion 34 of the central bore 30 of the healing abutment.

FIGS. 13A and 13B provide cross-sectional views of healing abutments engaging the abutment screw in a retention position. In the retained (or retention) position, the abutment and screw can be carried together to the patient's mouth prior to installation or during removal without the screw falling out of the bore or having to be installed separately. The drive, or internal portion of the screw head that receives the driver (shown here as hexagonally shaped and tapered) is designed such that the driver can retain or hold the screw when the two parts are engaged. The corresponding shape of the driver is tapered to form a press fit with the screw when the driver is advanced into the drive of the screw such that the screw stays engaged with the driver during delivery to the patient. As a result, the clinician can deliver the screw to the mouth while holding only the driver without the need to separately hold or deliver the screw. FIG. 13A shows the screw threads 66 engaging with the internal retention threads 36 of the healing abutment. FIG. 13B depicts the screw 60 in a retained position in which the screw thread portion 66 has been screwed to the internal threads 36 of the healing abutment 100, engaging with the deepest thread.

While the invention has been described with reference to example embodiments, it will be understood by those skilled in the art that a variety of modifications, additions and deletions are within the scope of the invention, as defined by the following claims.

What is claimed is:

1. A system of anatomical healing abutments for dental implant surgery, comprising:
a plurality of different healing abutments, each having an anatomical portion corresponding to a shape of a cementoenamel junction of a natural tooth type and a marking protocol comprising at least a first visual marking on a supragingival surface,
wherein the first visual marking is configured to provide visual identification by a practitioner of information about the healing abutment in an oral cavity, and
wherein a shape of the supragingival surface is used digitally to detect implant location and/or orientation.

2. The system of claim 1, wherein each of the plurality of healing abutments is provided in at least two different heights based on a desired natural tooth type, implant location, and implant depth.

3. The system of claim 1, wherein each of the plurality of healing abutments is provided in at least two different sizes of the anatomical portion based on the desired tooth type, implant location, and implant size.

4. The system of claim 1, wherein each of the plurality of different healing abutments comprises a surface modification on at least a supragingival surface, wherein the surface modification is configured to provide improved scannability.

5. The system of claim 1, wherein each of the plurality of different healing abutments comprises a channel configured for cooperative engagement with a corresponding abutment screw, wherein a head of the abutment screw sits near the supragingival surface to seal the channel.

6. The system of claim 1, wherein a connection portion comprises a visual indicator selected from color coding or laser markings that corresponds to one or both of a connection type or size of a dental implant.

7. The system of claim 1, wherein at least one of the different healing abutments includes a second visual marking.

8. The system of claim 7, wherein the second visual marking is a dimple.

9. The system of claim 1, wherein the marking protocol is not used to digitally detect implant location or orientation.

10. An anatomical healing abutment comprising:
a connection portion configured for engagement with a dental implant; and
an anatomical portion integrally connected to the connection portion, wherein a supragingival surface has an anatomical shape corresponding to a shape of a cementoenamel junction of a natural tooth type and a marking protocol comprising at least one visual marker configured to provide visual identification to the practitioner of a height and/or buccal-lingual orientation of the anatomical healing abutment,
wherein a shape of the supragingival surface is used digitally to detect implant location and/or orientation.

11. The anatomical healing abutment of claim 10, further comprising a second visual marking configured to provide visual identification to the practitioner one or both of a size or type of the connection portion.

12. The anatomical healing abutment of claim 10, wherein the connection portion forms a butt joint with a top surface of the dental implant, wherein the connection portion comprises an alignment feature that positions the healing abutment when engaged with the dental implant, and wherein the at least one visual marker is oriented to the alignment feature.

13. The anatomical healing abutment of claim 10, wherein the connection portion engages an internal recess of the dental implant, wherein the connection portion comprises an alignment feature that positions the healing abutment when engaged with the dental implant, and wherein the at least one visual marker is oriented to the alignment feature.

14. The anatomical healing abutment of claim 10, wherein the connection portion comprises color coding that corresponds to one or both of a connection size or type of a dental implant.

15. The anatomical healing abutment of claim 10, wherein at least one surface of the anatomical portion comprises a surface modification configured to provide improved scannability.

16. The anatomical healing abutment of claim 10, wherein the anatomical healing abutment corresponds to a maxillary central incisor natural tooth and comprises a concave occlusal surface and a rounded pentagonal occlusal shape.

17. The anatomical healing abutment of claim 10, wherein the anatomical healing abutment corresponds to a maxillary lateral incisor or a mandibular incisor natural tooth and comprises a concave occlusal surface and a rounded ovoid occlusal shape.

18. The anatomical healing abutment of claim 10, wherein the anatomical healing abutment corresponds to a maxillary canine natural tooth and comprises a concave occlusal surface and a rounded diamond occlusal shape.

19. The anatomical healing abutment of claim 10, wherein the anatomical healing abutment corresponds to a mandibular canine or a premolar natural tooth and comprises a concave occlusal surface and an oval occlusal shape, where the shape is longer buccolingually than mesiodistally.

20. The anatomical healing abutment of claim 10, wherein the anatomical healing abutment corresponds to a maxillary molar natural tooth and comprises a convex occlusal surface and a rounded rectangular occlusal shape, where the shape is longer buccolingually than mesiodistally.

21. The anatomical healing abutment of claim 10, wherein the anatomical healing abutment corresponds to a mandibular molar natural tooth and comprises a convex occlusal surface and a rounded rectangular occlusal shape, where the shape is shorter buccolingually than mesiodistally.

22. A system of anatomical healing abutments for dental implant surgery, comprising:
at least one healing abutment comprising:
a connection portion configured for engagement with a dental implant;
an anatomical portion integrally connected to the connection portion, wherein the anatomical portion has an anatomical shape corresponding with a shape of a cementoenamel junction of a natural tooth type, and wherein the anatomical portion comprises a supragingival surface comprising a first visual marker, wherein a shape of the supragingival surface is used to digitally to detect implant location and/or orientation,
wherein the first visual marker is a notch configured to provide visual identification to the practitioner of a height and/or buccal-lingual orientation of the anatomical healing abutment, wherein the first visual marker is not used digitally to detect implant location and/or orientation, and
wherein at least one of the healing abutments in the system comprises a second visual marker, wherein the second visual marker is comprised of one or more dimples configured to provide visual identification to the practitioner of one or both of a size and type of the connection portion; and
wherein when the healing abutment is engaged with the dental implant, a head of an abutment screw is substantially flush with the supragingival surface to form a seal.

23. The system of claim 22, wherein the at least one healing abutment comprises an internal bore comprising retention threads that retain a screw during installation and/or removal of the healing abutment.

24. The system of claim 22, further comprising a screw, the screw comprising a drive configured to form a press-fit connection with a compatible screwdriver.
